(19) United States
(12) Patent Application Publication
(10) Pub. No.: US 2025/0069199 A1
(43) Pub. Date: Feb. 27, 2025

(54) MULTI-CAMERA DEVICE AND METHODS FOR REMOVING SHADOWS FROM IMAGES

(71) Applicant: SAMSUNG ELECTRONICS CO., LTD., Suwon-si (KR)

(72) Inventors: Nazrinbanu Nurmohammad NAGORI, Bangalore (IN); Mrinmoy SEN, Bangalore (IN); Venkat Ramana PEDDIGARI, Bangalore (IN); Sai Pradyumna CHERMALA, Bangalore (IN); Praful MATHUR, Bangalore (IN); Darshana Venkatesh MURTHY, Bangalore (IN); Moonhwan JEONG, Suwon-si (KR)

(73) Assignee: SAMSUNG ELECTRONICS CO., LTD., Suwon-si (KR)

(21) Appl. No.: 18/945,107

(22) Filed: Nov. 12, 2024

Related U.S. Application Data
(63) Continuation of application No. PCT/KR2023/006192, filed on May 8, 2023.

(30) Foreign Application Priority Data
May 12, 2022 (IN) 202241027494
Oct. 12, 2022 (IN) 202241027494

(51) Int. Cl. G06T 5/60; G06T 5/50; G06T 7/00

(52) U.S. Cl. CPC G06T 5/60; G06T 5/50; G06T 7/0002; G06T 2207/10144; G06T 2207/20084; G06T 2207/30168

(57) ABSTRACT

A method may include: receiving, by a first camera of a multi-camera device, a first image of an input scene; identifying at least one shadow in the first image; determining at least one of at least one property of the at least one shadow or a region of interest (ROI) of the at least one shadow in the first image; applying at least one configuration to a second camera for obtaining a second image of the input scene based on the at least one of at least one property of the at least one shadow or the ROI of the at least one shadow, to identify at least one additional context of the input scene, where the at least one additional context is not obtained using the first camera; and removing the at least one shadow from the first image, based on the first image and the second image.

### CROSS-REFERENCE TO RELATED APPLICATIONS

This application is a continuation application of International Application No. PCT/KR2023/006192 designating the United States, filed on May 8, 2023, in the Korean Intellectual Property Receiving Office and claiming priority to Indian Provisional Patent Application No. 202241027494, filed on May 12, 2022 and Indian Patent Application number 202241027494, filed on Oct. 12, 2022, in the Indian Patent Office, the disclosures of which are incorporated by reference herein in their entireties.

### BACKGROUND

### 1. Field

Embodiments disclosed herein relate to image capturing devices, and more particularly to a multi-camera device and methods to effectively remove shadows, when capturing an image.

### 2. Description of Related Art

Shadows can occlude salient regions in an image and may be unwanted in certain scenarios. For example, in images, a shadow may fall on a human face or a shadow may prevent a text to be visible on a document. Shadows can cause issues such as, failure in object tracking, segmentation and face recognition algorithms in computer vision tasks.

Image capturing while ensuring sufficient amount of light can result in images without shadows. However, this may not be practical, as maintaining a well-lit environment cannot be ensured every time.

Existing mechanisms provide shadow removal, which can be applied, post the capture of images. However, existing shadow removal mechanisms cannot accurately recreate texture details because of the loss of details in the shadow region while capturing the image.

Existing Artificial Intelligence (AI) based shadow removal solutions struggle to output a convincing image, when the shadows in the image obscure texture and color information. FIG. 1 shows related art a shadow removal method 100 which takes an input image 102 from a camera along with a shadow mask 104 as input and outputs a shadow free image 106. However, the shadow region cannot be lit during the capture without adversely affecting the non-shadow regions.

### SUMMARY

Embodiments herein disclose a multi-camera device and methods for effective shadow removal when capturing an image based on multiple camera images.

Embodiments herein also disclose a multi-camera device and methods to obtain an image using a second camera to identify additional information, which is not identified by the first camera, wherein the image obtained by the second camera can be used for efficient shadow removal.

Embodiments herein also disclose a multi-camera device and methods to automatically remove shadows in real-time by analyzing properties of shadow and utilizing multiple cameras with adaptively determined zoom and exposure parameters for removing shadows.

According to one or more example embodiments, a method for removing at least one shadow from an image, may include: receiving, by a multi-camera device, a first image of an input scene from a first camera of the multi-camera device; identifying, by the multi-camera device, at least one shadow in the first image; determining, by the multi-camera device, at least one of at least one property of the at least one shadow or a region of interest (ROI) of the at least one shadow in the first image; applying, by the multi-camera device, at least one configuration to a second camera for obtaining a second image of the input scene based on the at least one of at least one property of the at least one shadow or the ROI of the at least one shadow, to identify at least one additional context of the input scene, where the at least one additional context is not obtained using the first camera; and removing, by the multi-camera device, the at least one shadow from the first image, based on the first image and the second image.

The at least one property of the at least one shadow may include at least one of a shadow intensity, a shadow complexity, shadow area, or a shadow type.

The ROI of the at least one shadow may be a shadow mask which indicates an area of the at least one shadow.

The second camera may include at least one of a wide angle camera, a telephoto camera, an optical zoom camera, a standard camera, or an ultra-wide camera for obtaining the second image to identify the at least one additional context of the input scene.

The at least one additional context may include at least one of lighting conditions, object colors, finer details, or textures of the input scene.

The method further may include: providing an icon for the removing the at least one shadow based on a shadow removing event.

The at least one configuration of the second camera may include at least one of an optical zoom level or an exposure time.

The method further may include: removing the at least one shadow from the first image, based on the at least one of the at least one property of the at least one shadow or the ROI obtained from the first image, or the at least one additional context obtained from the second image.

The method further may include: applying the at least one configuration as the optical zoom level of the second camera for the removing the at least one shadow; determining, by the multi-camera device, the at least one of the at the least one property of the at least one shadow or the ROI of the at least one shadow in the first image captured by the first camera, using a first Artificial Intelligence (AI) model; selecting, by the multi-camera device, the optical zoom level of the second camera for obtaining the second image to identify the at least one additional context of the input scene, based on the at least one of the at least one property of the at least one shadow or the ROI of the at least one shadow; analyzing, by the multi-camera device, the at least one of the at the least one property of the at least one shadow or the ROI of the first image or the at least one additional context of the second image; and removing, by the multi-camera device, the at least one shadow when capturing the image by the first camera using a second AI model, based on the analyzing of the first image and the second image.

The method further may include: selecting the optical zoom level from at least one of a zoom-in or a zoom-out.

The method further may include: applying the at least one configuration as an exposure time of the second camera for the removing the at least one shadow; determining, by the multi-camera device, the at least one of the at the least one property of the at least one shadow or the ROI of the at least one shadow in the first image captured by the first camera, using the first AI model; varying, by the multi-camera device, the exposure time for the second camera for obtaining the second image to identify the at least one additional context of the input scene, based on the at least one of the at least one property of the at least one shadow or the ROI of the at least one shadow; analyzing, by the multi-camera device, the at least one of the at the least one property of the at least one shadow or the ROI of the first image or the at least one additional context of the second image; and removing, by the multi-camera device, the at least one shadow when capturing the image by the first camera using a second AI model, based on the analyzing of the first image and the second image.

The varying the exposure time may include adjusting a time range from at least one of a lower to higher range or a higher to lower range.

According to one or more example embodiments, a multi-camera device may include: a first camera and a second camera; memory storing instructions; and at least one processor operatively connected to the memory, the first camera, and the second camera, wherein the at least one processor is configured to execute the instructions to: receive a first image of an input scene from the first camera; identify at least one shadow in the first image; determine at least one of at least one property of the at least one shadow or a region of interest (ROI) of the at least one shadow in the first image; apply at least one configuration to the second camera for obtaining a second image of the input scene based on the at least one of the at least one property of the at least one shadow or the ROI of the at least one shadow, to identify at least one additional context of the input scene, where the at least one additional context is not obtained using the first camera; and remove the at least one shadow from the first image, based on the first image and the second image.

The at least one property of the at least one shadow may include at least one of a shadow intensity, a shadow complexity, shadow area, or a shadow type.

The ROI of the at least one shadow is a shadow mask which indicates an area of the at least one shadow.

The second camera may include at least one of a wide angle camera, a telephoto camera, an optical zoom camera, a standard camera, or an ultra-wide camera for obtaining the second image to identify the at least one additional context of the input scene.

The at least one additional context may include at least one of lighting conditions, object colors, finer details, or textures of the input scene.

The at least one processor is further configured to execute the instructions to: providing an icon for the removing the at least one shadow based on a shadow removing event.

The at least one configuration of the second camera may include at least one of an optical zoom level or an exposure time.

According to one or more example embodiments, a method for removing at least one shadow from an image, may include: capturing, by a first camera of a multi-camera device, a first image of an input scene; identifying, by at least one processor of the multi-camera device, at least one shadow in the first image; determining, by the at least one processor of the multi-camera device, an area of the first image covered by the at least one shadow; capturing, by a second camera the multi-camera device, a second image of a portion of the input scene may include the area of the first image covered by the at least one shadow, the second camera having a larger focal length and using a longer exposure time than the first camera; and overlaying, by the at least one processor of the multi-camera device, the second image on the first image to remove the at least one shadow from the first image.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 shows a shadow removal method which takes an input image from a camera along with a shadow mask as input and outputs a shadow free image, according to related art;

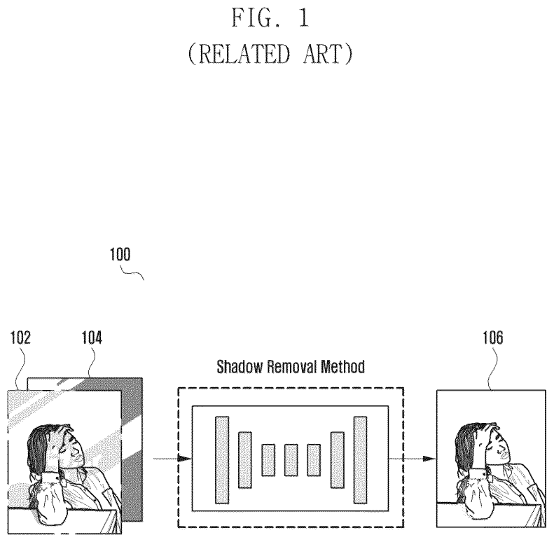

FIG. 2 shows a multi-camera device for removing shadows from an image when capturing the image, according to embodiments as disclosed herein;

FIG. 3 shows an example diagram for a shadow removal method using the multi-camera device, according to embodiments as disclosed herein;

FIG. 4 shows a detailed method of the shadow evaluator, according to embodiments as disclosed herein;

FIG. 5A shows one or more examples of shadow detection images and corresponding shadow mask images, according to one or more embodiments as disclosed herein;

FIG. 5B shows one or more examples of shadow detection images and corresponding shadow mask images, according to one or more embodiments as disclosed herein;

FIG. 5C shows one or more examples of shadow detection images and corresponding shadow mask images, according to one or more embodiments as disclosed herein;

FIG. 5D shows one or more examples of shadow detection images and corresponding shadow mask images, according to one or more embodiments as disclosed herein;

FIG. 5E shows one or more examples of shadow detection images and corresponding shadow mask images, according to one or more embodiments as disclosed herein;

FIG. 5F shows one or more examples of shadow detection images and corresponding shadow mask images, according to one or more embodiments as disclosed herein;

FIG. 6 shows an example scenario indicating selection of the optical zoom level configuration by the controller, according to embodiments as disclosed herein;

FIG. 7 shows an example scenario indicating selection of the zoom-in configuration by the controller, according to embodiments as disclosed herein;

FIG. 8 shows an example scenario indicating selection of the exposure time configuration by the controller, according to embodiments as disclosed herein;

FIG. 9 shows an example method of controlling the multi-camera image capturing by the controller, according to embodiments as disclosed herein;

FIG. 10 shows an example scenario indicating shadow removal using the multi-camera device, according to embodiments as disclosed herein;

FIG. 11 shows a detailed functional diagram for shadow removal using the multi-camera device, according to embodiments as disclosed herein;

FIG. 12 shows a detailed shadow removal method by the multi-camera device, according to embodiments as disclosed herein;

FIG. 13 shows a method for removing an artefact from an image when capturing the image, according to embodiments as disclosed herein;

FIG. 14 shows a method for removing a shadow from an image when capturing the image while applying both configurations of optical zoom level and the exposure time to the second camera, according to embodiments as disclosed herein;

FIG. 15 shows an example use case of a real-time shadow free preview in the multi-camera device, according to embodiments as disclosed herein;

FIG. 16 shows an example use case of a quick and direct sharing of images, according to embodiments as disclosed herein;

FIG. 17 shows an example use case of a real time object detection/classification, according to embodiments as disclosed herein; and

FIG. 18 shows an example use case of a real time object tracking, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

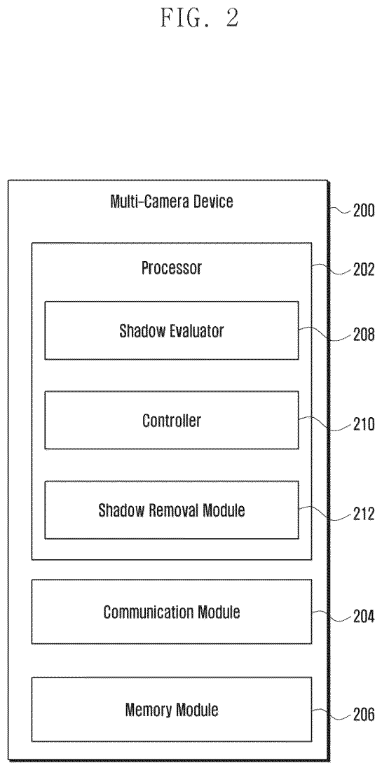

The embodiments herein achieve a multi-camera device and methods for effective shadow removal when capturing an image based on multiple camera images. Referring now to the drawings, and more particularly to FIGS. 2 through 18, where similar reference characters denote corresponding features consistently throughout the figures, there are shown embodiments. The shadow may be an artefact representing a darkened, shaded or blurred area of the image due to a shadow or a reflection.

FIG. 2 shows a multi-camera device 200 for removing shadow(s) from an image when capturing the image. The multi-camera device 200 comprises at least one processor 202, a communication module 204, and a memory module 206. The multi-camera device 200 further comprises multiple cameras including at least a first camera and a second camera.

In one or more embodiments herein, the processor 202 can be configured to evaluate a shadow present in a scene captured by the first camera using an Artificial Intelligence (AI) model in real-time. The processor 202 can identify a plurality of properties of the shadow from the shadow. The shadow properties can be utilized intelligently in conjunction with other cameras present in the multi-camera device 200 to extract additional context in the shadow region which is not captured in a first image. The processor 202 can analyze the shadow properties and the additional context in the shadow region to output an enhanced shadow-free image.

The processor 202 further comprises a shadow evaluator 208, a controller 210, and a shadow removal module 212.

In one or more embodiments herein, the shadow evaluator 208 can receive a first image of an input scene from the first camera in real-time and identify at least one shadow or artefact in the first image. The shadow or shadow free images can be identified using a classification technique in the first AI model. The first AI model is a multi-task model based on a convolutional neural network (CNN). The shadow evaluator 208 can determine at least one property of the shadow or artefact and a region of interest (ROI) of the shadow, if the shadow or artefact is identified in the first image. The shadow properties and the ROI are determined using the classification and segmentation techniques in the first AI model. The classification and segmentation techniques are implemented as part of the multi-task models based on the CNN. The determined information can be transmitted to the controller 210.

Examples of the artefact can be, but not limited to a shadow and reflection. The property of the shadow can be a pre-decided attribute which comprises at least one of a shadow intensity, a shadow complexity, a shadow area and a shadow type. Examples of the shadow intensity can be, but not limited to a light intensity, a medium intensity, and a dark intensity. Examples of the shadow complexity can be, but not limited to, a simple shape, complex shape, and highly complex shape. The ROI of the shadow may include a location information of at least one area of the shadow. The ROI of the shadow can be represented in the form of a shadow mask which indicates an area or location of the shadow. The shadow area can be indicated as a percentage in the image.

In one or more embodiments herein, the shadow evaluator 208 may utilize the first AI model for determining the property of the shadow and the ROI from the first image which is captured by the first camera. The first AI model can be a trained deep neural network or a trained CNN. Specifically, the CNN can be trained to classify the image frames. In other embodiment herein, shadow evaluator 208 can utilize a traditional algorithm for determining the property of the shadow and the ROI from the first image.

In one or more embodiments herein, the controller 210 can be configured to receive the property of the shadow and the ROI of the shadow, as determined by the shadow evaluator 208. The controller 210 can apply at least one configuration to the second camera based on the property of the shadow and the ROI of the shadow. The controller 210 implements an intelligent algorithm using multiple decision combinations for deciding the configuration for the second camera. Examples of the configuration of the second camera can be, but not limited to an optical zoom level, exposure time, aperture, International Standards Organization (ISO) levels, exposure level (over-exposure/under-exposure), and/or a combination of two or more of them. For example, the optical zoom level may comprise a lower zoom level when shadows covering large area are identified, and a higher zoom level when shadows covering less area are identified.

Based on the configuration set by the controller 210, a second image can be captured by the second camera. The controller 210 can be configured to obtain at least one additional context of the input scene from the second image. The additional context is the additional data or information which is not captured by the first camera. Examples of the context can be, but not limited to lighting conditions, object colors, finer details, and textures of the at least one property of the shadow. In one or more embodiments herein, the additional data can be obtained from the zoomed version of the image which may recreate finer details of the image providing a shadow free output image. In one or more embodiments herein, the additional data can be obtained from the camera exposure which may decide the amount of light that reaches the camera sensor when picture is captured. The image may be brighter or darker based on the exposure time. The controller 210 then communicates with the camera system to get the additional image frames as determined and passes them to the shadow removal module 212 along with the original image frame and the determined information from the shadow evaluator 208.

In one or more embodiments herein, the second camera can be, but not limited to a wide angle camera, a telephoto camera, a standard camera, and an ultra-wide camera for obtaining the second image to obtain the additional context from the input scene.

In one or more embodiments herein, the shadow removal module 212 can be configured to analyze the at least one property of the shadow and the ROI (shadow mask) obtained from the first image and the at least one context obtained from the second image, which are received from the controller 210. The shadow removal module 212 can remove the shadow from the first image when capturing the image by the first camera, based on the first image and the second image i.e., the analyzed information to produce a more realistic and accurate output.

In one or more embodiments herein, the shadow removal module 212 may utilize a second AI model for removing the shadow from the first camera while capturing. The second AI model can be at least one of a trained deep neural network or a trained CNN. The deep neural network or the CNN can be trained on a plurality of shadow removal datasets. In other embodiment herein, the shadow removal module 212 may utilize a traditional algorithm for removing the shadow from the first camera while capturing.

In one or more embodiments herein, the communication module 204 is configured to enable communication between the multi-camera device 200 and a server through a network or cloud. In one or more embodiments herein, the server may be configured or programmed to execute instructions of the multi-camera device 200. In one or more embodiments herein, the communication module 204 may enable the device 200 to store images in the network or the cloud, or the server.

In one or more embodiments herein, the communication module 204 through which the multi-camera device 200 and the server communicate may be in the form of either a wired network, a wireless network, or a combination thereof. The wired and wireless communication networks may comprise but not limited to, GPS, GSM, LAN, Wi-Fi compatibility, Bluetooth low energy as well as NFC. The wireless communication may further comprise one or more of Bluetooth (registered trademark), ZigBee (registered trademark), a short-range wireless communication such as UWB, a medium-range wireless communication such as Wi-Fi (registered trademark) or a long-range wireless communication such as 3G/4G or WiMAX (registered trademark), according to the usage environment.

In one or more embodiments herein, the processor 202 may comprise one or more of microprocessors, circuits, and other hardware configured for processing. The processor 202 can be configured to execute instructions stored in the memory module 206.

The processor 202 can be at least one of a single processer, a plurality of processors, multiple homogeneous or heterogeneous cores, multiple Central Processing Units (CPUs) of different kinds, microcontrollers, special media, and other accelerators. The processor 202 may be an application processor (AP), a graphics-only processing unit such as a graphics processing unit (GPU), a visual processing unit (VPU), and/or an Artificial Intelligence (AI)-dedicated processor such as a neural processing unit (NPU).

In one or more embodiments herein, the memory module 206 may comprise one or more volatile and non-volatile memory components which are capable of storing data and instructions to be executed.

Examples of the memory module 206 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 206 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 206 may, in some examples, be considered a non-transitory storage medium. The term “non-transitory” may indicate that the storage medium is not embodied in a carrier wave or a propagated signal. However, the term “non-transitory” should not be interpreted to mean that the memory module 206 is non-movable. In certain examples, a non-transitory storage medium may store data that can, over time, change (e.g., in Random Access Memory (RAM) or cache).

FIG. 2 shows example units of the multi-camera device 200, but it is to be understood that other embodiments are not limited thereon. In other embodiments, the multi-camera device 200 may include less or more number of modules. Further, the labels or names of the modules are used only for illustrative purpose and does not limit the scope of the invention. One or more modules can be combined together to perform same or substantially similar function in the multi-camera device 200.

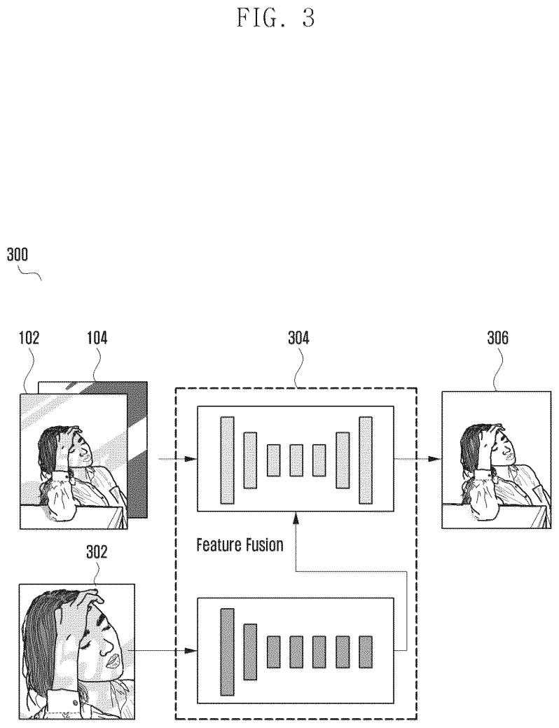

FIG. 3 shows an example diagram for a shadow removal method 300 using the multi-camera device 200. As depicted, the shadow removal method 300 comprises the operations of receiving the first image 102 from the first camera, a shadow mask 104 which is identified from a shadow of the first image 102, and a second image 302 from the second camera which is captured based on the configuration set by the controller 210.

During the capture of the first image 102, the first camera can analyze a scene and automatically detect the shadow in the first image and create a binary or non-binary shadow mask 104. The shadow masks from the first image can be produced using the segmentation technique in the first AI model. The segmentation technique can be implemented as a multi task model based on the CNN. The second camera such as a telephoto lens or any optical zoom lens with a larger focal length can be configured to capture fine texture details in the area of the shadow mask 104.

The first camera with the normal mode can capture the entire image region which enables to detect the shadow from the captured image. While the second camera such as telephoto lens or any optical zoom lens can capture image with additional context details such as texture or color details within the ROI of the captured image.

Thereafter, features from the second image 302 containing additional context are encoded by the controller 210. The encoded features are then fused 304 with features obtained from the first image 102 to obtain a shadow free image 306 with enhanced quality. Hence, using multiple cameras, a single image can be generated with the removal of unwanted shadows.

The various actions in method 300 may be performed in the order presented, in a different order or simultaneously. Further, in some embodiments, some actions listed in FIG. 3 may be omitted.

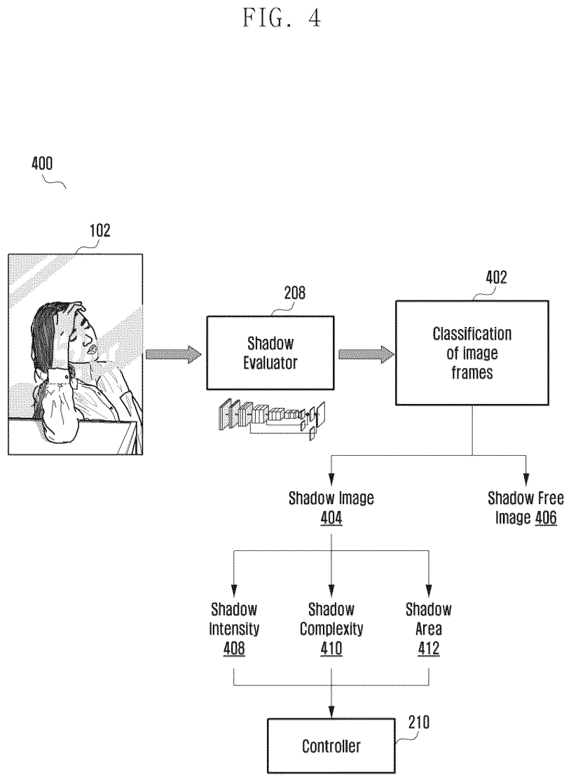

FIG. 4 shows a detailed method 400 of the shadow evaluator 208. The incoming image frames from the first camera can be sampled at regular intervals and passed to the shadow evaluator 208. For example, the first image 102 is passed to the shadow evaluator 208. Next, classification of the images is carried out in operation 402. The shadow evaluator 208 utilizes a trained CNN to classify the image frames i.e., the first image 102 based on the presence of shadow in the image.

The first image 102 can be classified either into a shadow image 404 or a shadow free image 406 based on presence of the shadow. The shadow evaluator 208 can identify the presence or absence of shadows in the first image 102, and on identifying the shadow, the shadow evaluator 208 can provide various shadow properties present in the image.

The shadow evaluator 208 predicts a set of pre-decided attributes such as, but not limited to the shadow intensity 408, the shadow complexity 410, the shadow area 412, and a shadow mask indicating the location of the shadow. The shadow intensity 408 can be categorized in light, medium, dark etc. The shadow complexity 410 can be categorized in a simple shape, complex shape, highly complex shape etc. The shadow area 412 can be categorized as a percentage of the image. These classified predictions are then sent to the controller 210 which handles the multi-camera capture.

The various actions in method 400 may be performed in the order presented, in a different order or simultaneously. Further, in some embodiments, some actions listed in FIG. 4 may be omitted.

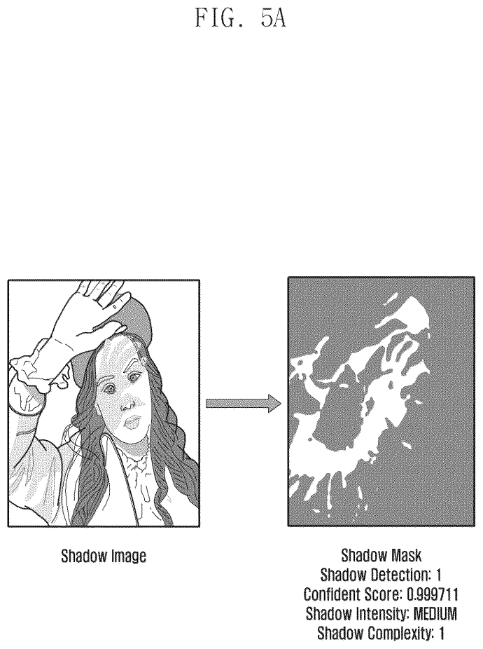

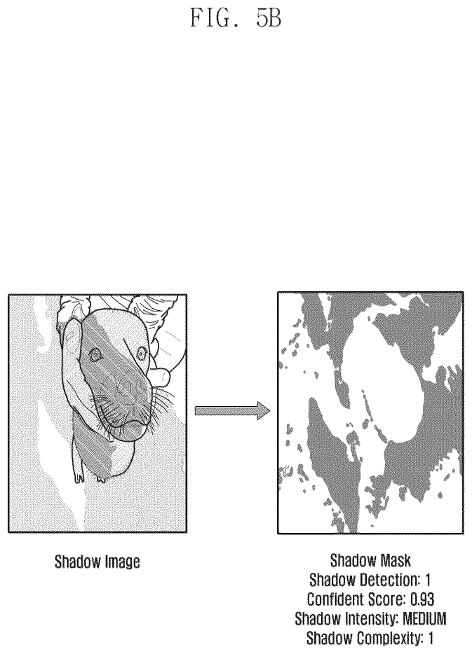

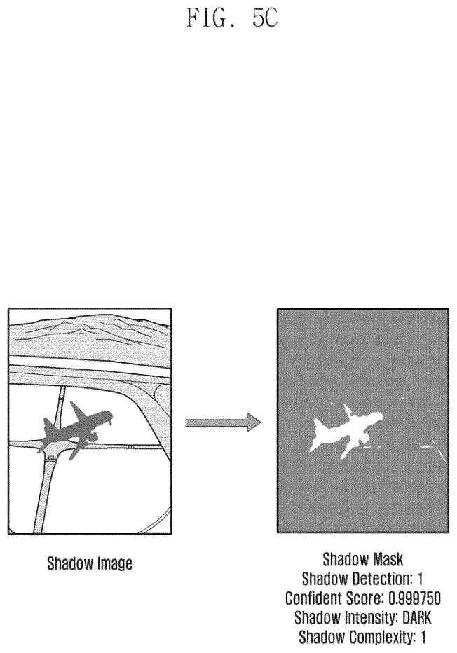

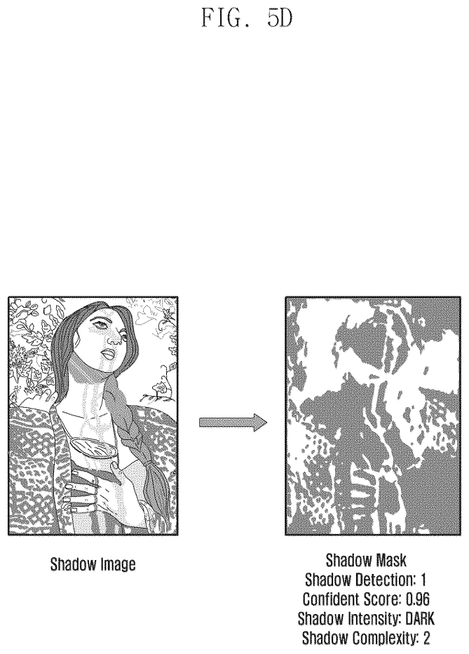

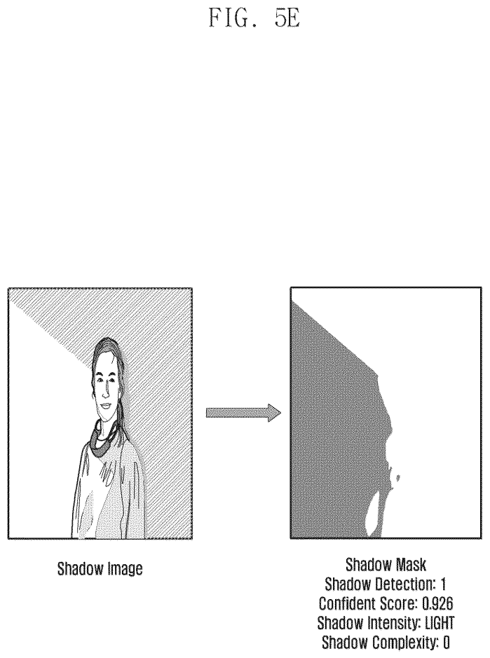

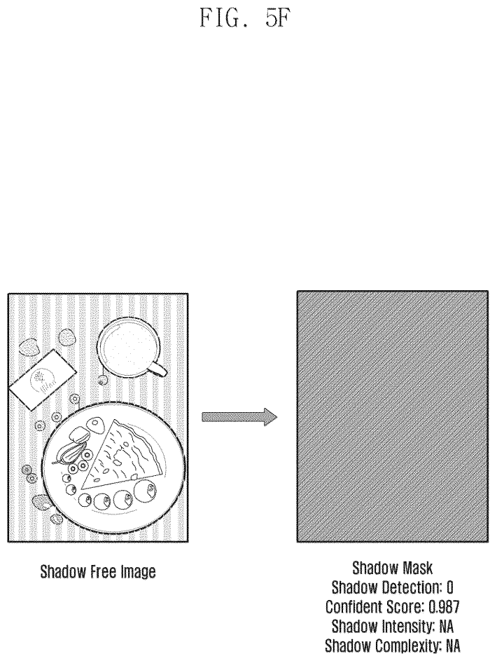

FIGS. 5A-5F shows different examples of shadow detection images and corresponding shadow mask images. The shadow evaluator 208 is configured with pre-decided shadow properties. Table 1 shows a pre-decided configuration of multiple shadow properties such as shadow detection, shadow intensity, shadow complexity, and shadow area. This classification of pre-decided shadow properties facilitates in identifying shadow or shadow free images, shadow properties and the ROI of the images.

TABLE 1

| | Label |
|---|---|
| Shadow Detection | |
| Shadow Free | 0 |
| Shadow Image | 1 |
| Shadow Intensity | |
| Light | 0 |
| Medium | 1 |
| Dark | 2 |
| Shadow Complexity | |
| Low Complexity | 0 |
| Medium Complexity | 1 |
| High Complexity | 2 |
| Shadow Area | |
| Shadow Mask | |

FIG. 5A shows an example shadow image and corresponding shadow mask image displayed with classified shadow properties such as shadow detection as 1 if shadow is present, confident score as 0.999711, shadow intensity as medium, and shadow complexity as 1.

FIG. 5B shows an example shadow image and corresponding shadow mask image displayed with classified shadow properties such as shadow detection as 1 if shadow is present, confident score as 0.93, shadow intensity as medium, and shadow complexity as 1.

FIG. 5C shows an example shadow image and corresponding shadow mask image displayed with classified shadow properties such as shadow detection as 1 if shadow is present, confident score as 0.999750, shadow intensity as dark, and shadow complexity as 1.

FIG. 5D shows an example shadow image and corresponding shadow mask image displayed with classified shadow properties such as shadow detection as 1 if shadow is present, confident score as 0.96, shadow intensity as dark, and shadow complexity as 2.

FIG. 5E shows an example shadow image and corresponding shadow mask image displayed with classified shadow properties such as shadow detection as 1 if shadow is present, confident score as 0.926, shadow intensity as light, and shadow complexity as 0.

FIG. 5F shows an example shadow free image and corresponding shadow mask image displayed with classified shadow properties such as shadow detection as 0 if shadow is not present, confident score as 0.987, shadow intensity as not applicable (NA), and shadow complexity as NA.

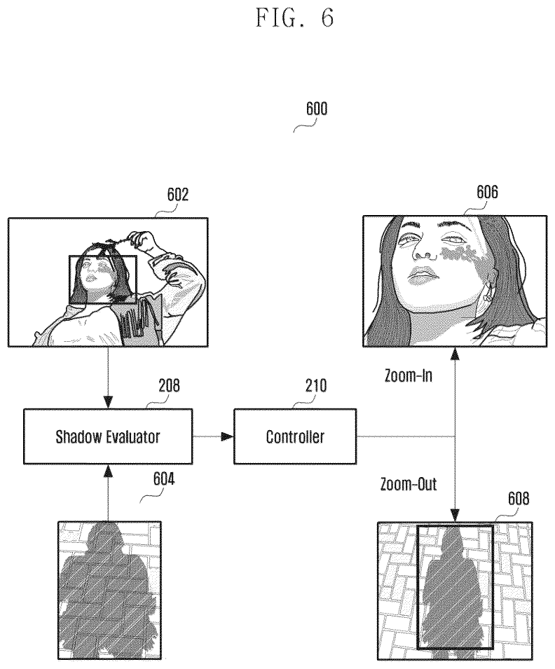

FIG. 6 shows an example scenario indicating selection of the optical zoom level configuration by the controller 210.

The diagram 600 shows two scenarios where a primary picture 602 or 604 is given as input to the shadow evaluator 208. The two pictures 602 and 604 are captured by the first camera. The pictures 602 and 604 are examples of two different scenes depending on which, different variety of secondary lenses are configured such as zoom-in for the primary picture 602 with a telephoto lens, and zoom-out for the primary picture 602 with an ultra-wide angle lens. The shadow evaluator 208 determines at least one property of the shadow and the ROI of the shadows identified in the pictures 602 and 604, using the first AI model.

The determined property of the shadow and the ROI of the shadows are sent to the controller 210. Based on the property of the shadow and the ROI, the controller 210 determines the optical zoom level as configuration for the second camera to capture additional images. Based on the additional images captured by the second camera, additional context of the scene can be extracted which is not available as a part of image captured using the first camera. The optical zoom level can be, but not limited to a zoom-in and a zoom-out configuration.

In one scenario, the controller 210 selects the zoom-in configuration for the second camera corresponding to the primary picture 602, based on at least one of the shadow intensity, shadow complexity, shadow area, shadow type and the ROI of the shadow identified in the primary picture 602. The second camera captures an auxiliary image 606 with the zoom-in configuration to obtain additional context of the scene which is not available in the primary picture 602 captured by the first camera.

In other scenario, the controller 210 selects the zoom-out configuration for the second camera corresponding to the secondary picture 604, based on at least one of the shadow intensity, shadow complexity, shadow area, shadow type and the ROI of the shadow identified in the secondary picture 604. The second camera captures an auxiliary image 608 with the zoom-out configuration to obtain additional context of the scene which is not available in the secondary picture 604 captured by the first camera.

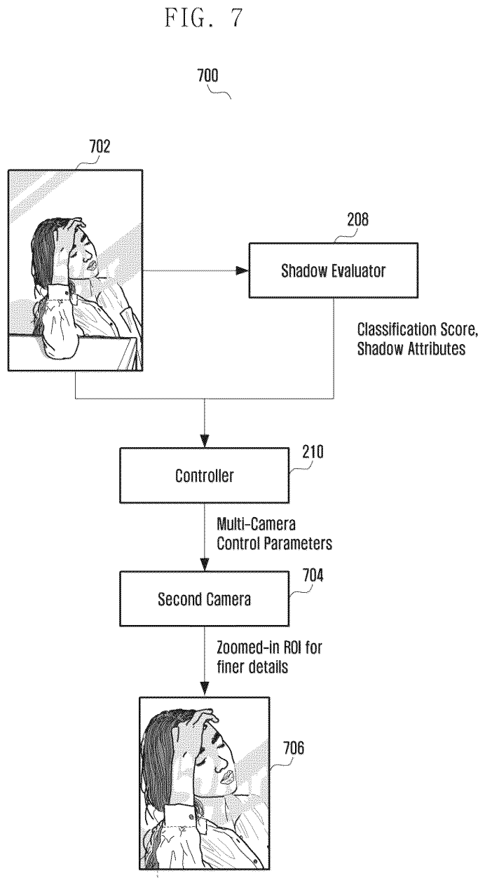

FIG. 7 shows an example scenario 700 indicating selection of the zoom-in configuration by the controller 210.

The first image 702 from the first camera is analyzed by the shadow evaluator 208 to classify plurality of shadow properties and provide a classification score of the first image 102. The classification score is derived using the classification technique in the first AI model, where the first AI model is implemented in the multi-task model based on the CNN. The controller 210 can be a rule-based or an intelligent system designed to decide on the applicability of the multi-camera capturing based on the determined information from the shadow evaluator 208. The controller 210 can determine multi-camera parameters such as configuration of the second camera 704 to capture the second image 706 for obtaining additional information that is not available in the first image 702.

For example, the configuration can comprise the exposure time, optical zoom level, aperture, ISO levels, exposure level (over-exposure/under-exposure), and/or a combination of two or more of them etc. For example, darker shadows might use longer exposures, and larger shadows use lower zoom level to cover the whole region of the shadow etc. The controller 210 may utilize a machine learning to design a model from existing datasets to determine the multi-camera parameters. The controller 210 can determine additional parameters for capturing the second image 604 such as a number of additional shots. Based on shadow properties such as shadow intensity (dark/light), the number of additional shots with variety of exposure time is captured using the second camera.

As depicted, the controller 210 selects a zoom-in ROI configuration of the second camera 704 to capture the second image 706 to obtain finer details of the shadow region. The controller 210 then obtains the second image 706 with zoomed-in finer details and communicates the details to the AI configured shadow removal module 212, along with the original image frame i.e., the first image 702 and the predictions from the shadow evaluator 208.

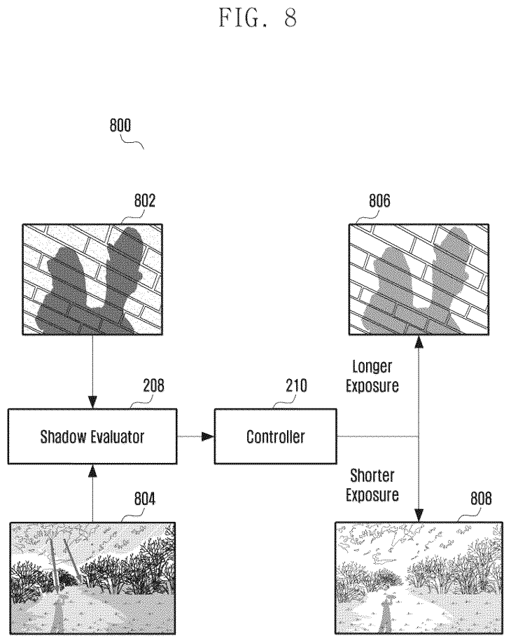

FIG. 8 shows an example scenario indicating selection of the exposure time configuration by the controller 210.

The diagram 800 shows two scenarios where a primary picture 802 or 804 is given as input to the shadow evaluator 208. The pictures 802 and 804 are captured by the first camera. The pictures 802 and 804 are examples of different scenes depending on which, different variety of secondary lenses are configured such as longer exposure for the primary picture 802 with dark shadow, and shorter exposure for the primary picture 804 with medium intensity shadow. The shadow evaluator 208 determines at least one property of the shadow and the ROI of the shadow identified in the pictures 802 and 804, using the first AI model.

The determined property of the shadow and the ROI of the shadow are sent to the controller 210. Based on the property of the shadow and the ROI, the controller 210 determines the exposure time as configuration for the second camera to capture additional images. The second camera is configured for capturing the additional context of the scene which is not available as a part of image captured using the first camera. The exposure time may comprise varying a time range from at least one of a lower range to higher range and a higher range to lower range.

In one scenario, the controller 210 selects a longer exposure time configuration for the second camera corresponding to the primary picture 802, based on at least one of the shadow intensity, shadow complexity, shadow area, shadow type and the ROI of the shadow identified in the primary picture 802. The second camera captures a auxiliary image 806 with the longer exposure time configuration to obtain additional context of the scene which is not available in the primary picture 802 captured by the first camera.

In other scenario, the controller 210 selects a shorter exposure time configuration for the second camera corresponding to the primary picture 804, based on at least one of the shadow intensity, shadow complexity, shadow area, shadow type and the ROI of the shadow identified in the primary picture 804. The second camera captures an auxiliary image 808 with the shorter exposure time configuration to obtain additional context of the scene which is not available in the primary picture 804 captured by the first camera. Varying the exposure time can result in providing additional details. For example as depicted in the primary picture 802, for a very dark shadow image captured by the first camera, the second camera can capture the auxiliary image 806 with a longer exposure time to obtain finer details in the dark shadow areas. In other example, as depicted in the primary picture 804, for a medium intensity shadow image captured by the first camera, the second camera can capture the auxiliary image 808 with a shorter exposure time to obtain finer details in the medium intensity shadow areas.

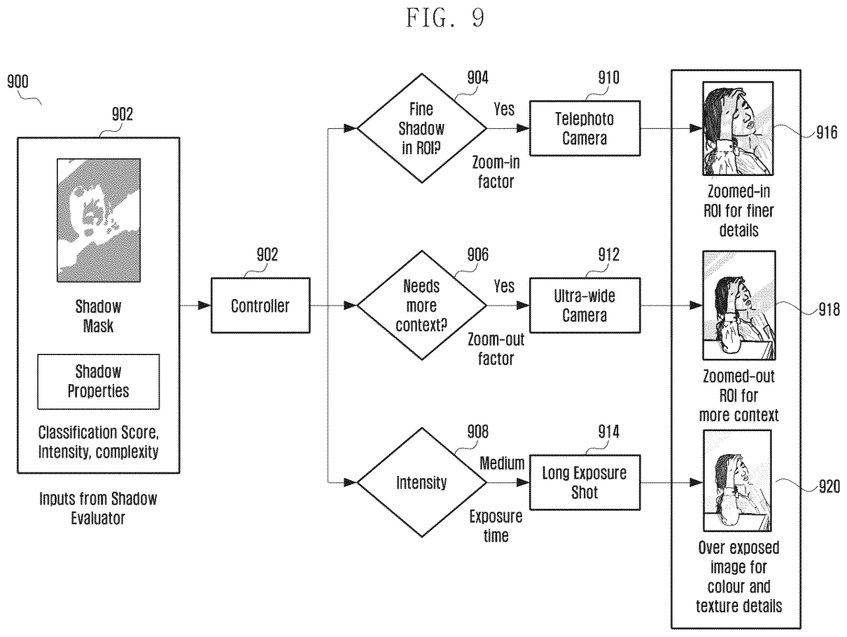

FIG. 9 shows an example method 900 of controlling the multi-camera image capturing by the controller 210.

The method 900 discloses receiving, by the controller 210, inputs from the shadow evaluator 208, as depicted in operation 902. The inputs to the controller 210 comprise shadow mask and the shadow properties of the input image. The shadow properties comprise a classification score, intensity, complexity etc.

The controller 210 carries out multiple checks such as verifying whether a fine shadow is present in the ROI of the input image as depicted in operation 904, verifying whether more context is desired which is not captured in the input image as depicted in operation 906, and verifying for the shadow intensity as depicted in operation 908.

If fine shadow is present, then the controller 210 selects the telephoto camera with zoom-in factor as configuration, as depicted in operation 910, to capture an additional image. The telephoto camera then provides a second output image with zoomed-in ROI for finer details, as depicted in operation 916.

If more context is desired, then the controller 210 selects the ultra-wide camera with zoom-out factor as configuration, as depicted in operation 912, to capture the additional image. The ultra-wide camera then provides a second output image with zoomed-out ROI with additional context, as depicted in operation 918.

If the shadow intensity is medium, then the controller 210 selects long exposure shot as configuration for an additional camera, as depicted in operation 914, to capture the additional image. The camera then provides an over exposed image for color and texture details, as depicted in operation 920.

The method 900 discloses example controls and paths implemented by the controller 210 based on the inputs from the shadow evaluator 208. However, each path may take multiple decision combinations such as zoom and exposure together.

The various actions in method 900 may be performed in the order presented, in a different order or simultaneously. Further, in some embodiments, some actions listed in FIG. 9 may be omitted.

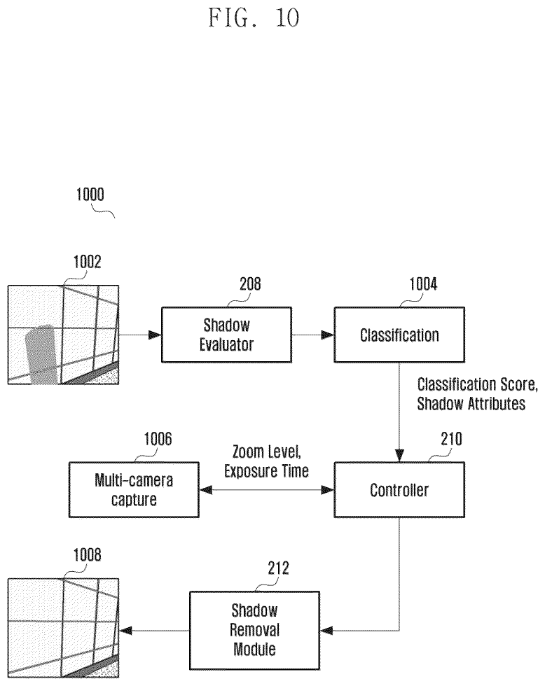

FIG. 10 shows an example scenario 1000 indicating shadow removal using the multi-camera device 200.

As depicted, the first image 1002 captured by the first camera is transmitted to the shadow evaluator 208. The shadow evaluator 208, in real-time, evaluates whether a shadow is present in the scene using the first AI model. If the shadow is detected, the first AI model classifies the detected shadow, as depicted in operation 1004, providing a classification score and shadow properties.

The first AI model identifies a set of shadow properties including the shadow intensity, shadow complexity, shadow area, and shadow type etc. The predicted shadow attributes are transmitted to the controller 210. The controller 210 analyzes the shadow properties and selects at least one of the zoom level and the exposure time for multi-camera capturing, as depicted in operation 1006.

The controller 210 can select a second camera with a configuration either zoom level or exposure time to capture the second image. The controller 210 further receives the second image and obtains additional context from the second image. Therefore, the predicted shadow attributes are used intelligently in conjunction with other camera lenses in the multi-camera device 200 to extract additional information on the color, texture, high resolution details etc. in the affected region.

The first image 1002 along with the detected shadow properties and the second image along with the additional context is transmitted to the shadow removal module 212, by the controller 210. The shadow removal module 212 utilizes the second AI model to output an enhanced shadow-free image 1008 based on the first image 1002 along with the detected shadow properties and the second image along with the additional context.

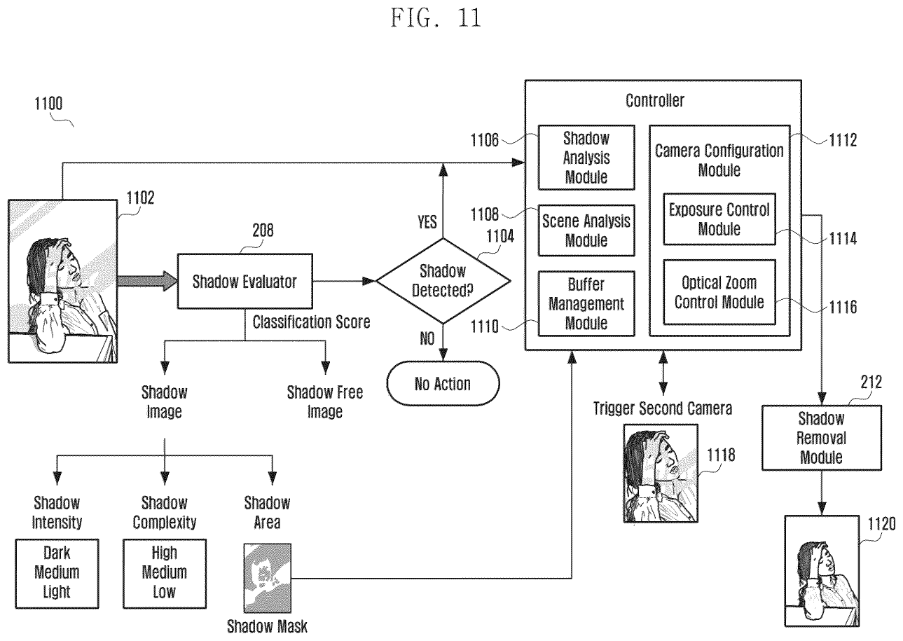

FIG. 11 shows a detailed functional diagram 1100 for shadow removal using the multi-camera device 200.

The diagram 1100 indicates that the first image 1102 of an input scene is captured and transmitted, by the first camera, as input to the shadow evaluator 208. The first image 1102 can be an RGB (Red, Green, and Blue) image. The shadow evaluator 208 classifies the first image 1102 either into a shadow image or a shadow free image based on the presence of shadow in the first image. The shadow evaluator 208 classifies the first image 1102 along with the classification score.

The identified shadow image is further categorized with the shadow properties such as shadow intensity, shadow complexity, shadow area etc. The shadow area can be indicated with a shadow mask which is the ROI of the shadow. If the shadow is detected in the first image 1102 as verified in operation 1104, then the first image, the shadow properties, the shadow mask are transmitted to the controller 210. If the shadow is not detected, then no action is taken.

The controller 210 comprises a shadow analysis module 1106, a scene analysis module 1108, a buffer management module 1110, and a camera configuration module 1112.

The shadow analysis module 1106 can be configured to analyze the information received from the shadow evaluator 208 i.e., the first image, the shadow properties, and the shadow mask. The shadow analysis module 1106 can be further configured to determine at least one context from the first image 1102 based on the analyzed information. For example, the context can be lighting conditions, object colors, finer details, and textures of the input scene.

The scene analysis module 1108 can be configured to analyze the information received from the shadow evaluator 208 i.e., the first image, the shadow properties, and the shadow mask. The scene analysis module 1108 can be further configured to determine scene parameters such as finding object, area, background, human, non-human etc. from the input scene based on the analyzed information.

Based on the context from the shadow analysis and the determined scene parameters from the scene analysis, the camera configuration module 1112 can be configured to determine a plurality of configuration parameters of multiple cameras of the multi-camera device 200. The configuration parameters of at least one second camera may be determined to capture the second image to obtain the additional context which is not available in the first image. The configuration parameters of the cameras may comprise either an optical zoom level or an exposure time or an aperture, ISO levels, exposure level (over-exposure/under-exposure), and/or a combination of two or more of them.

The camera configuration module 1112 further comprises an exposure control module 1114 and an optical zoom control module 1116. The exposure control module 1114 can be configured to receive the exposure time adjustment parameter from the camera configuration module 1112 for the second camera selected by the camera configuration module 1112. Thus, the exposure control module 1114 sets the exposure time of the second camera to capture the second image for obtaining the additional context which is not captured in the first image 1102.

Similarly, the optical zoom control module 1116 can be configured to receive the zoom level parameter from the camera configuration module 1112 for the second camera selected by the camera configuration module 1112. Thus, the optical zoom control module 1116 sets the zoom level of the second camera to capture the second image for obtaining the additional context which is not captured in the first image 1102.

The controller 210 can be further configured to trigger the second camera with the configuration parameters set by the camera configuration module 1112. The second camera captures the second image 1118 and transmits to the controller 210. The controller 210 receives the second image 1118 and obtains the additional context. The second image 1118 can be an RGB image. The controller 210 further transmits the first image along with the shadow properties and the shadow mask, and the second image along with the additional context to the shadow removal module 212.

The shadow removal module 212 can be configured to remove the shadow from the first image when capturing the image by the first camera, based on the information of the first image and the second image received from the controller 210. The shadow removal module 212 provides a shadow free image 1120 using the second AI model or a traditional algorithm. The shadow free image 1120 can be an RGB image.

In one or more embodiments herein, the buffer management module 1110 can be configured to manage the number of image frames used to capture based on the information received from the shadow analysis module 1106 and the scene analysis module 1108.

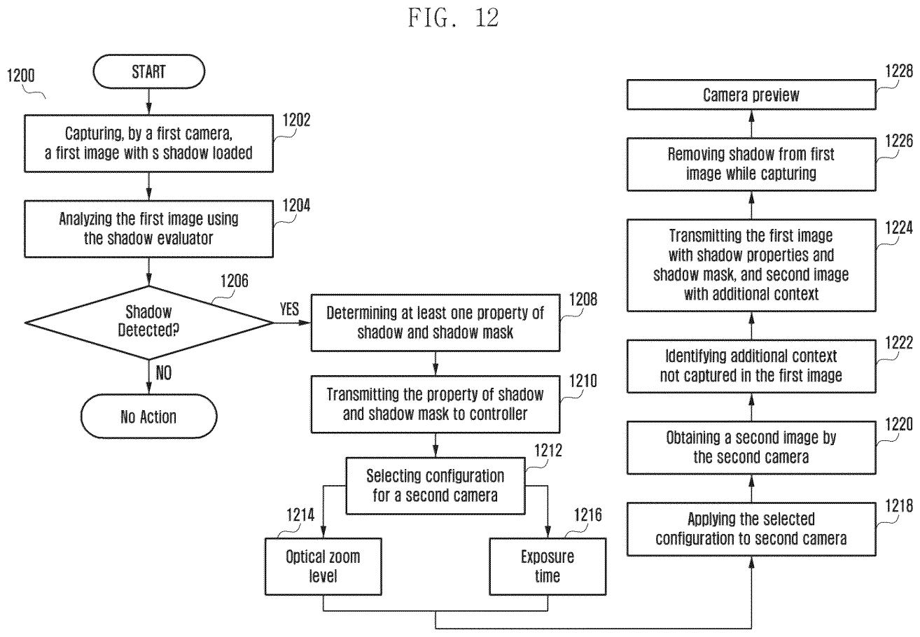

FIG. 12 shows a detailed shadow removal method 1200 by the multi-camera device 200. The method 1200 discloses capturing, by the first camera, the first image with a shadow loaded, as depicted in operation 1202. The first image can be the RGB input image. Subsequently, the method 1200 discloses analyzing, by the shadow evaluator 208, the first image, as depicted in operation 1204. The shadow evaluator 208 detects presence of the shadow in the first image, as depicted in operation 1206. If the shadow is detected, then the method 1200 discloses determining, by the shadow evaluator 208, at least one property of the shadow such as shadow complexity, shadow intensity and shadow area etc. and shadow mask, as depicted in operation 1208, of the detected shadow.

Thereafter, the method 1200 discloses transmitting, by the shadow evaluator 208, the property of the shadow and the shadow mask to the controller 210, as depicted in operation 1210. The shadow mask can be a binary or a non-binary shadow mask. Next, the method 1200 discloses selecting, by the controller 210, a configuration for the second camera, as depicted in operation 1212, based on the received property of the shadow and the shadow mask. The controller 210 may select either an optical zoom level as configuration for the second camera as depicted in operation 1214, or an exposure time as configuration for the second camera as depicted in operation 1216, or a combination of both the optical zoom level and the exposure time as configuration for at least one second camera. The second camera can be selected from, but not limited to a wide angle camera, an optical zoom camera, telephoto camera, a standard camera, and an ultra-wide camera etc.

Later, the method 1200 discloses applying, by the controller 210, the selected configuration to the second camera, as depicted in operation 1218. Thereafter, the method 1200 discloses obtaining, by the second camera, a second image, as depicted in operation 1220. The second image can be an RGB image. Subsequently, the method 1200 discloses obtaining, by the controller 210, additional context from the second image not captured in the first image, as depicted in operation 1222.

Later, the method 1200 discloses transmitting, by the controller 210, the first image with shadow properties and shadow mask, and the second image with additional context to the shadow removal module 212, as depicted in operation 1224. Subsequently, the method 1200 discloses removing, by the shadow removal module 212, the shadow from the first image while capturing by the first camera, as depicted in operation 1226, based on the received information of the first image and the second image. The shadow removal module 212 removes the shadow from the first image using the second AI model or a traditional algorithm. Thereafter, the method 1200 discloses providing the shadow free image as a camera preview on the multi-camera device 200, as depicted in operation 1228.

The various actions in method 1200 may be performed in the order presented, in a different order or simultaneously. Further, in some embodiments, some actions listed in FIG. 12 may be omitted.

In some embodiments, the method comprises: capturing, by a first camera of a multi-camera device, a first image of an input scene; identifying, by at least one processor of the multi-camera device, at least one shadow in the first image; determining, by the at least one processor of the multi-camera device, an area of the first image covered by the at least one shadow; capturing, by a second camera the multi-camera device, a second image of a portion of the input scene comprising the area of the first image covered by the at least one shadow, the second camera having a larger focal length and using a longer exposure time than the first camera; and overlaying, by the at least one processor of the multi-camera device, the second image on the first image to remove the at least one shadow from the first image.

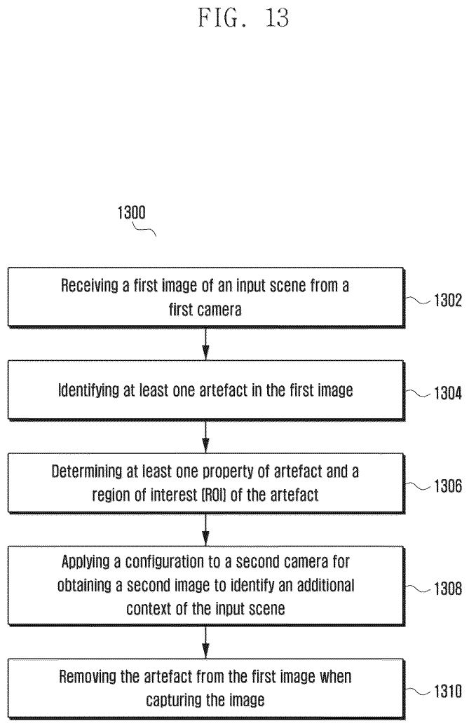

FIG. 13 shows a method 1300 for removing an artefact from an image when capturing the image. The method 1300 discloses receiving, by the shadow evaluator 208, a first image of an input scene from a first camera of the multi-camera device 200, as depicted in operation 1302. Thereafter, the method 1300 discloses identifying, by the shadow evaluator 208, at least one artefact in the first image, as depicted in operation 1304. Examples of the artefact can be, but not limited to a shadow and a reflection in the image.

Subsequently, the method 1300 discloses determining, by the shadow evaluator 208, at least one of at least one property of the artefact and the ROI of the artefact in the first image, as depicted in operation 1306. Examples of the property of the artefact can be, but not limited to an artefact intensity, an artefact complexity, an artefact area, and an artefact type. The ROI of the artefact is in the form of an artefact mask which indicates an area of the artefact.

Thereafter, the method 1300 discloses applying, by the controller 210, at least one configuration to a second camera for obtaining the second image of the input scene based on the property of the artefact and the ROI of the artefact, as depicted in operation 1308. The second image is captured to obtain at least one additional context of the input scene, where the additional context is not captured using the first camera. The configuration to the second camera can be, but not limited to an optical zoom level, an exposure time, an aperture, ISO levels, an exposure level (over-exposure/under-exposure), and/or a combination of two or more of them.

Subsequently, the method 1300 discloses removing, by the shadow removal module 212, the artefact from the first image when capturing the image, as depicted in operation 1310, based on the first image and the second image. In detail, the artefact is removed based on the property of the artefact and the artefact mask obtained from the first image and the additional context obtained from the second image.

The various actions in method 1300 may be performed in the order presented, in a different order or simultaneously. Further, in some embodiments, some actions listed in FIG. 13 may be omitted.

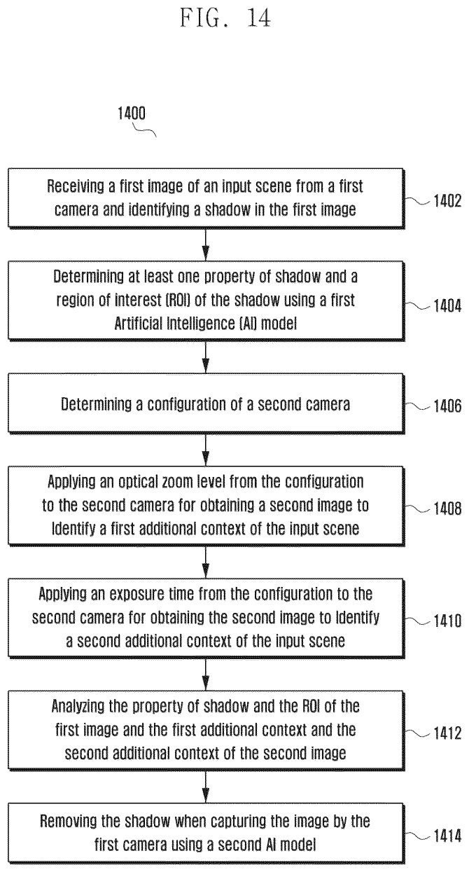

FIG. 14 shows a method 1400 for removing a shadow from an image when capturing the image while applying both configurations of optical zoom level and the exposure time to the second camera.

The method 1400 discloses receiving, by the shadow evaluator 208, a first image of an input scene from a first camera and identifying at least one shadow in the first image, as depicted in operation 1402. Subsequently, the method 1400 discloses determining, by the shadow evaluator 208, at least one of at least one property of the shadow and ROI of the at least one shadow in the first image, using the first AI model or a traditional algorithm, as depicted in operation 1404. The ROI of the shadow is in the form of a shadow mask indicating an area of the at least one shadow.

Thereafter, the method 1400 discloses determining, by the controller 210, at least one configuration of a second camera, as depicted in operation 1406, on determining the at least one property of the shadow and the ROI of the shadow. Later, the method 1400 discloses applying, by the controller 210, an optical zoom level from the configuration to the second camera, as depicted in operation 1408. The second camera captures a second image of the input scene to obtain a first additional context of the input scene, where the first additional context is an additional context which is not captured using the first camera.

Subsequently, the method 1400 discloses applying, by the controller 210, an exposure time from the configuration to the second camera, as depicted in operation 1410. The second camera captures the second image of the input scene to obtain the second additional context of the input scene, where the second additional context is an additional context which is not captured using the first camera. The second image is captured with a combination of the first additional context and the second additional context.

Thereafter, the method 1400 discloses analyzing, by the shadow removal module 212, the property of the shadow and the ROI of the first image, and the first additional context and the second additional context of the second image, as depicted in operation 1412. Later, the method 1400 discloses removing, by the shadow removal module 212, the shadow when capturing the image by the first camera using a second AI model or a traditional algorithm, as depicted in operation 1414. The shadow is removed based on the analysis of the first image and the second image.

The various actions in method 1400 may be performed in the order presented, in a different order or simultaneously. Further, in some embodiments, some actions listed in FIG. 14 may be omitted.

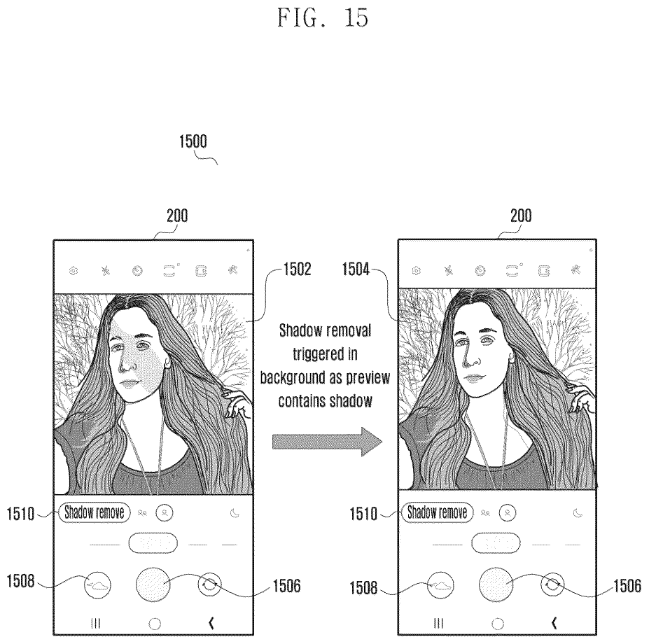

FIG. 15 shows an example use case 1500 of a real-time shadow free preview in the multi-camera device 200. As depicted, when the user starts capturing an image using the proposed multi-camera device 200, the image is displayed as a camera preview with a shadow 1502 on subject. As the image contains shadow, the shadow removing method is triggered by the multi-camera device 200 in background, and a shadow free preview 1504 is displayed.

According to one or more embodiments, the shadow removing method may be activated by default without a user input. According to one or more embodiments, the shadow removing method may be activated as an option such that the shadow removing method option is selected to be set through a camera setting menu of the multi-camera device 200.

According to one or more embodiments, the multi-camera device 200 may generate a shadow free image in response to receiving an input through an image capturing button 1506 for capturing an image. The shadow removing method may be performed in background. Based on the generated shadow free image, a smaller version thereof may be displayed on a preview area 1508. When the preview area 1508 is selected by a touch input, the generated shadow free image may be displayed on the shadow free preview 1504.

According to one or more embodiments, the shadow removing method may be activated as an option if the shadow removing method option is selected through a shadow remove icon 1510, for removing shadow, which is provided on the multi-camera device 200. The multi-camera device 200 may generate a shadow free preview image in response to receiving an input through the shadow remove icon 1510. The shadow removing method may be performed in background. The generated shadow free preview image may be displayed on a preview area 1508. The shadow free preview image is removed from the preview area 1508, and the camera preview with a shadow 1502 may again displayed in response to receiving another input through the shadow remove icon 1510. The shadow remove icon 1510 may be used for activating or deactivating the shadow removing method option. Then the user may check the result of the shadow removing method option and select the image capturing button 1506 to generate the shadow free image.

According to one or more embodiments, a shadow removing event may be occurred when the image capturing button 1506 or the shadow remove icon 1510 is selected. The shadow removing event may include an event of triggering a process for generating the shadow free image upon capturing the image with the shadow or an event of triggering a process for generating the shadow free preview image before capturing the image with the shadow.

Thus, using the proposed shadow removal framework, the user can instantly check how the shadow free image may look like in the camera preview itself.

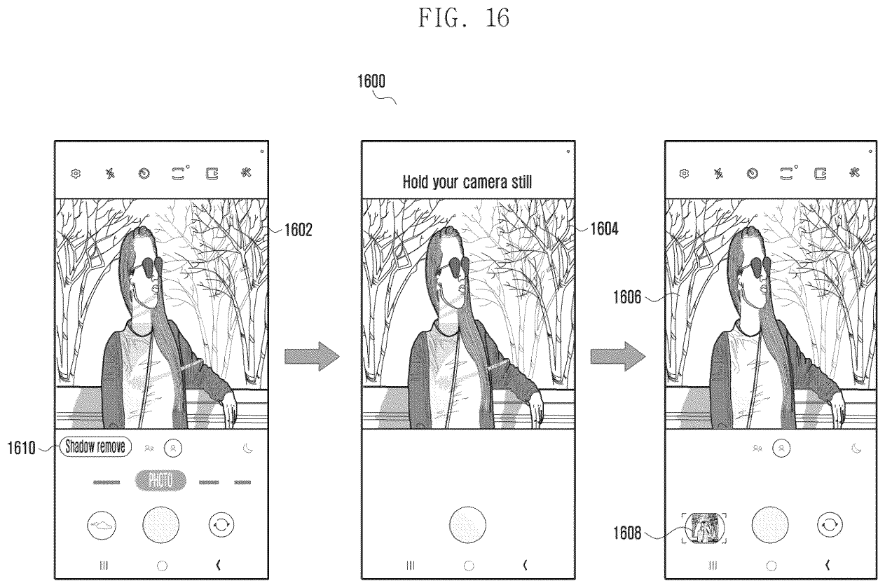

FIG. 16 shows an example use case 1600 of a quick and direct sharing of images. As depicted, when the user starts capturing an image using the proposed multi-camera device 200, the image is displayed as a camera preview with a shadow 1602 on subject.

As the image contains shadow, the shadow removing method is triggered by the multi-camera device 200 in background indicating the preview 1604 to hold the camera still. The shadow evaluator 208 is automatically enabled for evaluating the shadow, and a high quality capture of the ROI area from the second camera is initiated by the controller 210. Later, the shadow is removed from the image based on the captured image from the second camera and a shadow free preview 1606 is displayed. Further, the multi-camera device 200 provides an option 1608 on the preview screen for quickly sharing the shadow free preview 1606. The shadow removing method may be activated by default without a user input. Alternatively, the shadow removing method may be activated as an option therefor is selected through a camera setting menu of the multi-camera device 200. Alternatively, the shadow removing method may be activated as an option therefor is selected through an icon 1610, for removing shadow, which is provided on the multi-camera device 200.

In the proposed shadow removal framework, the shadows can be removed in an automated fashion right during the capturing. This enables the users to directly and quickly share the images on social media platforms without performing a manual post-processing.

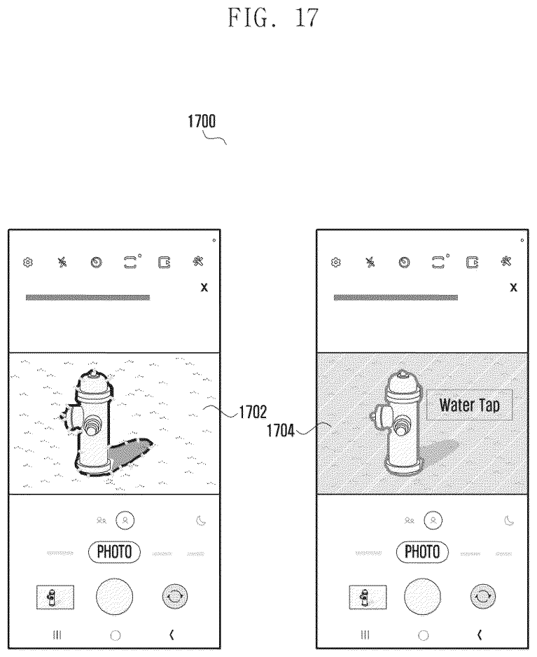

FIG. 17 shows an example use case 1700 of a real time object detection/classification. Using the proposed shadow removal framework, shadows are detected in real time and removing shadows in background enables accuracy improvement for detection of objects.

As depicted, when the user starts capturing an image using the proposed multi-camera device 200, the object shape is displayed as a camera preview with a shadow 1702, identified as inaccurate image and therefore the object detection fails. As the image contains shadow, the shadow removing method is triggered by the multi-camera device 200 in background, and the object is accurately detected as water tap which is indicated at 1704.

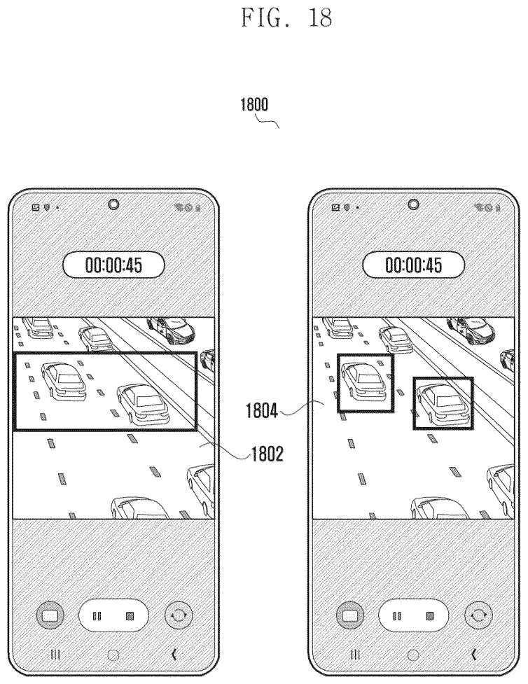

FIG. 18 shows an example use case 1800 of a real time object tracking. With the proposed shadow removal framework, shadows are detected in real time and removing shadows in background enables accuracy improvement for tracking of objects

As depicted, when the user starts capturing an image using the proposed multi-camera device 200, the image 1802 indicates merged representation of different cars driving together. In other embodiments herein, the image 1802 can indicate separate blobs representation of different people walking close to each other.

When the shadow removing method is triggered by the multi-camera device 200 in background, the output image 1804 is generated which isolates and tracks people/objects in a group much easier and accurate.

The proposed method adaptively utilizes multiple cameras to improve the shadow removal performance. The efficient/lightweight aspect of the shadow removal method can be deployed on a smartphone and work in real-time.

The embodiments disclosed herein can be implemented through at least one software program running on at least one hardware device. The elements shown in FIG. 2 include blocks which can be at least one of a hardware device, or a combination of hardware device and software module.

The embodiment disclosed herein describes a multi-camera device 200 for removing at least one shadow from an image when capturing the image. Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

What is claimed is:

1. A method for removing at least one shadow from an image, comprising:
receiving, by a multi-camera device, a first image of an input scene from a first camera of the multi-camera device;
identifying, by the multi-camera device, at least one shadow in the first image;
determining, by the multi-camera device, at least one of at least one property of the at least one shadow or a region of interest (ROI) of the at least one shadow in the first image;
applying, by the multi-camera device, at least one configuration to a second camera for obtaining a second image of the input scene based on the at least one of at least one property of the at least one shadow or the ROI of the at least one shadow, to identify at least one additional context of the input scene, where the at least one additional context is not obtained using the first camera; and
removing, by the multi-camera device, the at least one shadow from the first image, based on the first image and the second image.

2. The method as claimed in claim 1, wherein the at least one property of the at least one shadow comprises at least one of a shadow intensity, a shadow complexity, shadow area, or a shadow type.

3. The method as claimed in claim 1, wherein the ROI of the at least one shadow is a shadow mask which indicates an area of the at least one shadow.

4. The method as claimed in claim 1, wherein the second camera comprises at least one of a wide angle camera, a telephoto camera, an optical zoom camera, a standard camera, or an ultra-wide camera for obtaining the second image to identify the at least one additional context of the input scene.

5. The method as claimed in claim 1, wherein the at least one additional context comprises at least one of lighting conditions, object colors, finer details, or textures of the input scene.

6. The method as claimed in claim 1, further comprising:
providing an icon for the removing the at least one shadow based on a shadow removing event.

7. The method as claimed in claim 1, wherein the at least one configuration of the second camera comprises at least one of an optical zoom level or an exposure time.

8. The method as claimed in claim 1, further comprising:
removing the at least one shadow from the first image, based on the at least one of the at least one property of the at least one shadow or the ROI obtained from the first image, or the at least one additional context obtained from the second image.

9. The method as claimed in claim 6, further comprising:
applying the at least one configuration as the optical zoom level of the second camera for the removing the at least one shadow;
determining, by the multi-camera device, the at least one of the at the least one property of the at least one shadow or the ROI of the at least one shadow in the first image captured by the first camera, using a first Artificial Intelligence (AI) model;
selecting, by the multi-camera device, the optical zoom level of the second camera for obtaining the second image to identify the at least one additional context of the input scene, based on the at least one of the at least one property of the at least one shadow or the ROI of the at least one shadow;
analyzing, by the multi-camera device, the at least one of the at the least one property of the at least one shadow or the ROI of the first image or the at least one additional context of the second image; and
removing, by the multi-camera device, the at least one shadow when capturing the image by the first camera using a second AI model, based on the analyzing of the first image and the second image.

10. The method as claimed in claim 8, further comprising:
selecting the optical zoom level from at least one of a zoom-in or a zoom-out.

11. The method as claimed in claim 6, further comprising:
applying the at least one configuration as an exposure time of the second camera for the removing the at least one shadow;
determining, by the multi-camera device, the at least one of the at the least one property of the at least one shadow or the ROI of the at least one shadow in the first image captured by the first camera, using the first AI model;
varying, by the multi-camera device, the exposure time for the second camera for obtaining the second image to identify the at least one additional context of the input scene, based on the at least one of the at least one property of the at least one shadow or the ROI of the at least one shadow;
analyzing, by the multi-camera device, the at least one of the at the least one property of the at least one shadow or the ROI of the first image or the at least one additional context of the second image; and
removing, by the multi-camera device, the at least one shadow when capturing the image by the first camera using a second AI model, based on the analyzing of the first image and the second image.

12. The method as claimed in claim 11, wherein the varying the exposure time comprises adjusting a time range from at least one of a lower to higher range or a higher to lower range.

13. A multi-camera device comprising:
a first camera and a second camera;
memory storing instructions; and
at least one processor operatively connected to the memory, the first camera, and the second camera, wherein the at least one processor is configured to execute the instructions to:
receive a first image of an input scene from the first camera;
identify at least one shadow in the first image;
determine at least one of at least one property of the at least one shadow or a region of interest (ROI) of the at least one shadow in the first image;
apply at least one configuration to the second camera for obtaining a second image of the input scene based on the at least one of the at least one property of the at least one shadow or the ROI of the at least one shadow, to identify at least one additional context of the input scene, where the at least one additional context is not obtained using the first camera; and
remove the at least one shadow from the first image, based on the first image and the second image.

14. The multi-camera device as claimed in claim 13, wherein the at least one property of the at least one shadow comprises at least one of a shadow intensity, a shadow complexity, shadow area, or a shadow type.

15. The multi-camera device as claimed in claim 13, wherein the ROI of the at least one shadow is a shadow mask which indicates an area of the at least one shadow.

16. The multi-camera device as claimed in claim 13, wherein the second camera comprises at least one of a wide angle camera, a telephoto camera, an optical zoom camera, a standard camera, or an ultra-wide camera for obtaining the second image to identify the at least one additional context of the input scene.

17. The multi-camera device as claimed in claim 13, wherein the at least one additional context comprises at least one of lighting conditions, object colors, finer details, or textures of the input scene.

18. The multi-camera device as claimed in claim 13, wherein the at least one processor is further configured to execute the instructions to:
providing an icon for the removing the at least one shadow based on a shadow removing event.

19. The multi-camera device as claimed in claim 13, wherein the at least one configuration of the second camera comprises at least one of an optical zoom level or an exposure time.

20. A method for removing at least one shadow from an image, comprising:
capturing, by a first camera of a multi-camera device, a first image of an input scene;
identifying, by at least one processor of the multi-camera device, at least one shadow in the first image;
determining, by the at least one processor of the multi-camera device, an area of the first image covered by the at least one shadow;
capturing, by a second camera the multi-camera device, a second image of a portion of the input scene comprising the area of the first image covered by the at least one shadow, the second camera having a larger focal length and using a longer exposure time than the first camera; and
overlaying, by the at least one processor of the multi-camera device, the second image on the first image to remove the at least one shadow from the first image.
